(19) United States
(12) Patent Application Publication
(10) Pub. No.: US 2006/0083291 A1
(43) Pub. Date: Apr. 20, 2006

(54) Receiver apparatus, and associated method, for operating upon data communicated in a MIMO, multi-code, MC-CDMA communication system

(76) Inventors: Zheng Hongming, Beijing (CN); Anthony Reid, Irving, TX (US); Guan Hao, Beijing (CN); Teng Yong, Beijing (CN)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/967,023

(22) Filed: Oct. 15, 2004

(51) Int. Cl. H04B 1/707; H04K 1/10

(52) U.S. Cl. 375/148; 375/260

(57) ABSTRACT

Apparatus, and an associated method, for mitigating interference introduced upon data communicated to an MIMO receiver using an MC-CDMA communication system. The dimension of the received data is reduced to a single-representation in a manner in which inter-code and inter-antenna interference is mitigated.

The present invention relates generally to a manner by which to facilitate reception of data communicated in a MIMO (Multiple Input, Multiple Output) multi-code MC-CDMA (Multi-carrier-Code Division Multiple Access) communication system. More particularly, the present invention relates to apparatus, and an associated method, by which to mitigate both inter-code interference and inter-antenna interference introduced upon the data during its communication to a receiver that receives the data.

A unified receiver construction is provided that permits the inter-code and inter-antenna interference together to be mitigated, thereby to improve the quality of receiver operation, accurately to recreate the informational content of the transmitted data. A signal reception matrix of the data detected at the receive antennas of the receiver is converted from a multi-dimensional representation to a single-dimensional representation. And, once converted into the single-dimensional representation, the coding operations are performed to recover the informational content of the data.

### BACKGROUND OF THE INVENTION

Access to communication systems by which to communicate data is essential for many in modern society. During operation of a communication system, data is communicated between a set of communication stations that are interconnected by a communication channel. At least one of the communication stations forms a sending station that transmits the data, which is to be communicated, upon the communication channel. And, at least of one of the communication stations forms a receiving station that operates to detect the data communicated upon the communication channel. Once detected, operations are performed by the receiving station to recover the informational content of the data.

A wide variety of different types of communication systems have been developed and deployed to permit large numbers of users to communicate therethrough. And, as advancements in technology permit, new communication systems shall likely be developed and deployed.

A radio communication system is an exemplary type of communication system. A radio communication system utilizes radio communication channels to interconnect communication stations operable therein. Radio communication systems offer various advantages over their wireline counterparts. For instance, communication systems implemented as radio communication systems are generally of reduced costs relative to their wireline counterparts. And, communications by way of a radio communication system are possible between locations at which the formation of wireline connections, needed in a wireline communication system, would not be possible or practical. Additionally, a radio communication system is amenable for implementation as a mobile communication system in which one or more of the communication stations therein is permitted mobility.

A cellular communication system is an exemplary type of radio communication system. A cellular communication system is a multi-user, radio communication system that provides for telephonic communications with mobile stations. Successive generations of cellular communication systems have been installed throughout significant portions of the world. New-generation cellular communication systems provide for effectuation of data-intensive communication services.

Other radio communication systems exhibit some characteristics analogous to those of cellular communications systems. For instance, wireless local area networks (WLANs) also provide for communications with mobile stations. Data communication services are amongst the communication services that are available by way of a WLAN.

Planning for a subsequent-generation, a fourth-generation (4G), wireless communication system is ongoing. Proposals include MIMO (Multiple Input, Multiple Output) implementations in which a sending station and a receiving station each include multiple antennas. Separate data is communicated by separate ones of the multiple transmit antennas to form the multiple inputs, and separate detections are made at separate receive antennas, forming the multiple outputs of the system. An MIMO implementation is advantageous as the data throughput rate is a multiple of the achievable throughput rate using a conventional, single input, single output communication system implementation system.

While some proposals for MIMO make use of OFDM (Orthogonal Frequency Division Multiplexing) multi-carrier schemes, other proposals relate to multi-carrier-CDMA (MC-CDMA) schemes. Channel differentiation in such a scheme is, in part, provided by coding different data streams of the data with different spreading codes.

The data, transmitted as separate-data streams by the different transmit antennas is communicated upon communication channels that are susceptible to distortion. Both inter-code interference and inter-antenna distortion distorts the data. Inter-code interference occurs between different multi-codes, i.e., data streams, communicated upon a multi-path fading channel. And, inter-antenna interference is caused by interference between the independent data streams transmitted by the different transmit antennas distort the data during its communication to a receiving station. The inter-code and inter-antenna interference affects performance of the receiving station and, if of significant levels, can prevent proper operation of the communication system in that the receiving station is unable to recreate the informational content of the transmitted data.

Transmission schemes have been developed for MIMO systems in which data that is to be transmitted by different ones of the transmit antennas is coded prior to its application to, and transmission from, the transmit antennas. One scheme, referred to as double ABBA (DABBA), a transformed, multi-antenna double-rate block code, codes the data to form non-orthogonal codes in which a unitary transformation is applied to original, space time transmit diversity (STTD) blocks of data. Use of DABBA coding of the transmit data is advantageous as such coding provides increased levels of diversity and lessened amounts of inter-antenna interference.

When, however, the DABBA-coded data is transmitted in an MC-CDMA communication scheme, and conventional detection methods are utilized to detect and de-spread the received multi-code data, the inter-antenna and inter-code interference is unable adequately to be mitigated.

What is needed, therefore, is an improved manner by which to operate upon the received data in a manner better to mitigate the inter-antenna and inter-code interference introduced upon the data during its transmission to the receiving station.

It is in light of this background information related to the communication of data in an MIMO MC-CDMA communication system that the significant improvements of the present invention have evolved.

### SUMMARY OF THE INVENTION

The present invention, accordingly, advantageously provides apparatus, and an associated method, by which to facilitate reception of data communicated in an MIMO (Multiple Input, Multiple Output) multi-code, MC-CDMA communication system.

Through operation of an embodiment of the present invention, a manner is provided by which to mitigate both inter-code interference and inter-antenna interference introduced upon the data during its communication to a receiver that receives the data.

In one aspect of the present invention, a unified receiver construction is provided that permits the inter-code and inter-antenna interferences together to be mitigated, thereby to improve the quality of receiver operation to accurately recreate the informational content of the communicated data. While conventional detection methods for a receiving station that receives DABBA-coded, or other encoded, data sent during operation of an MIMO communication system is unable to adequately mitigate the inter-antenna and inter-code interference, the unified receiver construction provides for their complete mitigation.

Data detected at the receive antennas of the receiving station define a signal reception matrix having dimensions dependent upon the number of receive antennas. The signal reception matrix is multi-dimensional when the number of receive antennas is at least two. The multi-dimensional representation of the signal reception matrix is converted into a single-dimensional representation. And, then, the inter-antenna and inter-code interference is mitigated together during decoding of the single-dimensional data representation.

That is to say, in one aspect of the present invention, the DABBA signal matrix, or other coded signal matrix, of multiple dimensions is converted into a single dimension. And, once the signal matrix is converted into the single dimension, detection operations are performed upon the single-dimensional matrix. And, pursuant to the detection operation, the desired signal is obtained in which the interference is mitigated. The signal reception matrix is unified into standard signal matrix in which, then, the interference and diversity are considered at the same time.

In another aspect of the present invention, the conversion of the multi-dimensional signal reception matrix into the standard reception signal matrix of a single dimension is performed by multiplying the indications of the signal reception matrix by a matrix multiplicand and, in particular, the matrix multiplicand comprises a Hermetian of the product of a channel matrix and a spreading code matrix. Through the combination of this matrix multiplicand and the indications of the signal reception matrix, a single-dimensional, i.e., a one-dimensional, standard-reception signal matrix is formed.

In another aspect of the present invention, the resultant product of the signal reception matrix and the Hermetian of the channel and spreading code matrices are provided to a decoder, such as a MIMO algorithm, a BLAST algorithm, or a QRD-M algorithm, as appropriate to form values of the data that are free of inter-code and inter-antenna interference. The interference is mitigated completely when the MIMO detector is optimal.

Operation of an embodiment of the present invention is advantageously implemented in any of various MIMO systems that utilizes a coded, MC-CDMA communication scheme, including multi-user systems. For example, an embodiment of the present invention is implementable in a so-called fourth generation (4G) cellular communication system or wireless local area network.

A single unified receiver structure is provided for a MIMO communication system. The communication system utilizes any of various schemes, such as MIMO diversity, MIMO special or hybrid MIMO diversity, and special multiplexing (DABBA). The unified receiver structure exhibits performance levels that are significantly improved relative to conventional receiver structures.

In these and other aspects, therefore, apparatus, and an associated method, is provided to facilitate data reception at an MIMO receiver that receives coded, multi-carrier CDMA-modulated data at a set of receive antennas upon channels susceptible to distortion. A dimension converter is adapted to receive indications of decoded multi-carrier CDMA-modulated data detected at each receive antenna of the set of receive antennas. The dimension converter converts the indications of decoded, multi-carrier CDMA-modulated data into a single-dimensional data representation. An interference mitigator is adapted to receive indications of the single-dimensional data representation formed by the dimension converter. The interference mitigator mitigates interference introduced upon the coded, multi-carrier CDMA-modulated data during communication thereof upon the channels.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of an MIMO communication system in which an embodiment of the present invention is operable.

FIG. 2 illustrates a functional block diagram of another exemplary communication system in which an embodiment of the present invention is operable.

FIG. 3 illustrates a functional block diagram of portions of sending and receiving stations forming part of the communication system shown in FIG. 1.

FIG. 4 illustrates a method flow diagram listing the method of operation of an embodiment of the present invention.

### DETAILED DESCRIPTION

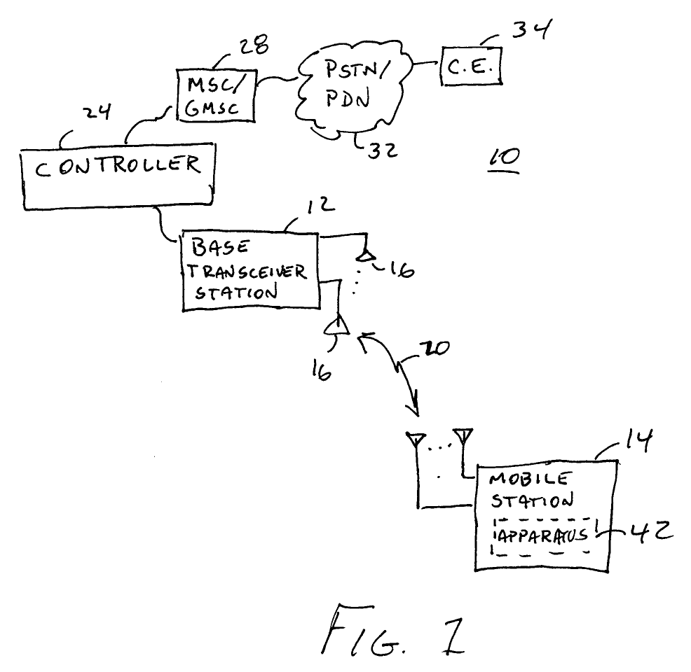

Referring first to FIG. 1, a communication system, shown generally at 10, provides for radio communications between communication stations 12 and 14. In the exemplary implementation shown in the figure, the communication station 12 forms a base transceiver station (BTS) of a cellular communication system, and the communication station 14 forms a mobile station operable in the cellular communication system. Both the base transceiver station and the mobile station are multiple-antenna transceivers that define an MIMO (Multiple Input, Multiple Output) communication arrangement. The following description shall describe exemplary operation of an embodiment of the present invention in which the station 12 forms the sending station and the station 14 forms the receiving station, operation in which the mobile station 14 forms the sending station and the base station 12 forms the receiving station can analogously be described.

The communication station forming the base transceiver station 12 is here shown to include N transmit antennas 16. And, the communication station forming the mobile station is here shown to include M receive antennas 18. In the MIMO arrangement, as shown, the data throughput permitted between the communication stations 12 and 14 is a multiple increase over the throughput rate permitted of a single input, single output arrangement. That is to say, because of the multiple antenna configuration, multiple, independent data streams are formable, available for communication from the different ones of the transmit antennas 16 in the forward link direction. Analogously, in a two-way communication scheme, multiple, independent data streams formed at the mobile station formed of the communication station 14 are formable, available for communication in a reverse link direction back to the communication station 12, analogously also at combined data throughput rates multiples of those available in a single input, single output arrangement.

The radio channels 20 upon which the data is communicated are not distortion free. Distortion caused, for instance, by interference between concurrently-communicated data streams distorts the values of the communicated data. This interference is sometimes also referred to as inter-antenna interference. When the data is delivered to a receiving station, here the communication station 14, compensation must be made to mitigate for the effects of the inter-antenna interference in order to recover correctly the informational content of the transmitted data.

In the exemplary implementation, the communications between the communication stations 12 and 14 is effectuated using a multi-carrier, code division, multiple access (MC-CDMA) communication scheme, the data communicated on the different radio channels is also susceptible to inter-code interference between the data streams that are coded by different spreading codes. This interference must also be mitigated in order to recover correctly the informational content of the data once delivered to a receiving station, here the mobile station forming the communication station 14.

The network part of the communication system is further here shown to include a controller 24 that is coupled to the base transceiver station 12, a mobile switching center/gateway (MSC/GWY) 28, a public switched telephonic network/packet data network (PSTN/PDN) 32, and a correspondent entity (CE) 34. The correspondent entity is representative of a communications device that forms a communication endpoint, a communication source or a communication drain, of data communicated during operation of the communication system.

The communication station 14, formed of a multiple-antenna implementation including a plurality of receive antennas 18 must be capable of detecting the data received at the different receive antennas and for operating upon the data detected thereat to recover the independent data streams and the values thereof so that the informational content of the communicated data can be recovered. As noted above, however, existing schemes by which to operate upon the detected data to recover the informational content thereof does not adequately mitigate the effects of inter-antenna and inter-code interference. Pursuant to operation of an embodiment of the present invention, a manner is provided by which to mitigate the effects of the inter-antenna and inter-code interference, thereby to permit more accurate recovery of the informational content of the data. The receive part of the communication station 14 includes apparatus 42 of an embodiment of the present invention that operates to facilitate the recovery of the informational content of the data in which the effects of inter-code and inter-antenna interference are mitigated. The apparatus forms a unified receiver structure connected to each of the receive antennas 18.

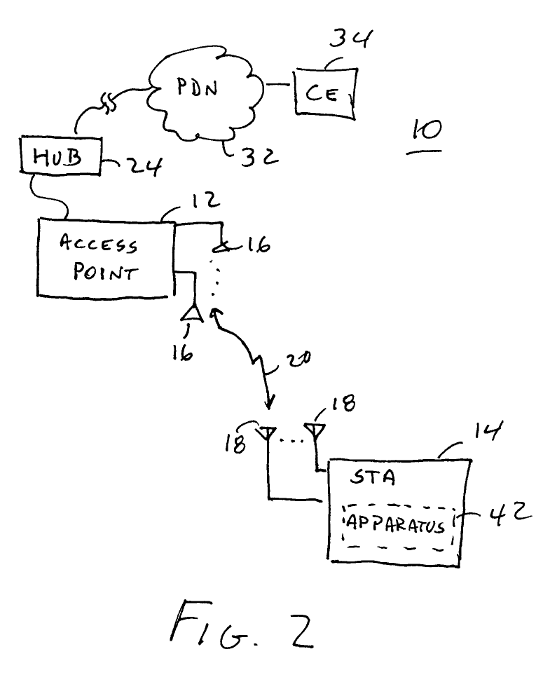

FIG. 2 illustrates a communication system 10 that also provides for radio communications between a set of communication stations 12 and 14. Here, the communication system forms a wireless local are network in which the communication station 12 forms an access point (AP) and the mobile station 14 forms a STA. The controller 24 forms a hub that is connected to a network 32 and, in turn, to the correspondent entity.

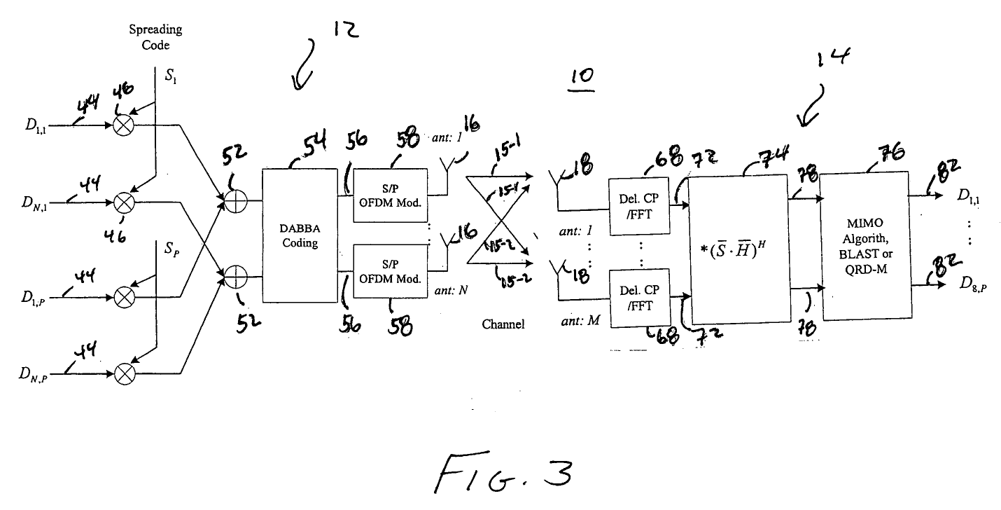

FIG. 3 illustrates representations of portions of the communication stations 12 and 14 that form parts of the communication system 10 shown in FIG. 1 or 2. The elements of the communication stations are functionally represented, implementable in any desired manner, including, in part, by algorithms executable by processing circuitry. Modulated symbols D that are to be communicated are provided on the lines 44. The values on the lines 44 form inputs to mixers 46. Spreading codes S are also provided to the mixers. Once mixed, sets of mixed signals are summed by summing elements 52. And, once summed, the summed values are provided to a coder 54. In the exemplary implementation, the ABBA coding is performed by the coder 54. And, coded data is provided by way of the lines 56 to a set of S/P OFDM (Orthogonal Frequency Division Multiplexing) modulators 58. And, once modulated, modulated symbols are provided to the transmit antennas 16. The antennas transmit separate data streams, here represented by the segments 15-1 and 15-2 to communicate the modulated data to the communication station 14.

The portion of the communication system 14 shown in FIG. 2 is the unified receiver structure 42 that is connected to each of the receive antennas 18. Here, a DEL.CP/FFT (Fast Fourier Transform) operator is connected to each of the receive antennas 18 and operates to generate transformed indications of the received data on the lines 72. The lines 72 extend to an operator 74 that operates to convert the dimension of the received data into a single-dimensional representation. The indications provided on each of the lines 74 defines a separate dimension, and the operator 74 converts the dimension of the data provided thereto into a single dimension. Specifically, here, the operator 74 forms a matrix multiplier that multiplies the received values by the Hermetian of the product of the matrix S and the matrix H. The matrix S is a matrix of spreading codes, and the matrix H is a matrix representation of the channel upon which the data is communicated.

The apparatus 42 further includes an operator 76 connected to receive the single-dimensional representations formed by the operator 74 by way of the lines 78. Mo algorithm, ABLAST, or CRD-M, or other appropriate decoder that operates to decode the representations provided thereto in a manner in which inter-antenna interference is mitigated. And, symbols D are generated on the lines 82, available for further processing at the receive part of the communication station.

The transmit part of the communication station 12 forms a DABBA coded MC-CDMA transmitter. The modulated symbols streams of the users, i.e., parties to communications, are first serial-two-parallel converted into NP branches and spread by Walsh-Hadamard codes of code links P. Once spread, the data is DABBA space-time coded and IFFT (Inverse Fast Fourier Transform) transformations are performed for each transmit antenna 16. For purposes of explanation, the spreading factor is assumed to equal the number of the multi-code. And, the symbol streams D applied on the lines 44 are denoted at the i-th transmission antenna and spread by the j-th code.

The DABBA coding is described mathematically as: where matrix

$$X = [ \begin{matrix}{X}_{A} & {X}_{B} \\ {X}_{B} & {X}_{A}\end{matrix} ] + [ \begin{matrix}{X}_{C} & {X}_{D} \\ - {X}_{D} & - {X}_{C}\end{matrix} ] where matrix \\ {X}_{A} = [ \begin{matrix}{A}_{1} & {A}_{2} \\ - {A}_{2}^{*} & {A}_{1}^{*}\end{matrix} ] , {X}_{B} = [ \begin{matrix}{B}_{1} & {B}_{2} \\ - {B}_{2}^{*} & {B}_{1}^{*}\end{matrix} ] , {X}_{C} = [ \begin{matrix}{C}_{1} & {C}_{2} \\ - {C}_{2}^{*} & {C}_{1}^{*}\end{matrix} ] , and \qquad ( 2 )$$

$${X}_{D} = [ \begin{matrix}{D}_{1} & {D}_{2} \\ - {D}_{2}^{*} & {D}_{1}^{*}\end{matrix} ]$$

are all the Alamouti codes.

Expanding the space time code X_{A}, X_{B}, X_{C} and X_{D} in formula (2), So the DABBA scheme for OFDM system has the following signal form,

$$X = [ \begin{matrix}{A}_{1} + {C}_{1} & {A}_{2} + {C}_{2} & {B}_{1} + {D}_{1} & {B}_{2} + {D}_{2} \\ - {( {A}_{2} + {C}_{2} )}^{*} & {( {A}_{1} + {C}_{1} )}^{*} & - {( {B}_{2} + {D}_{2} )}^{*} & {( {B}_{1} + {D}_{1} )}^{*} \\ {B}_{1} - {D}_{1} & {B}_{2} - {D}_{2} & {A}_{1} - {C}_{1} & {A}_{2} - {C}_{2} \\ - {( {B}_{2} - {D}_{2} )}^{*} & {( {B}_{1} - {D}_{1} )}^{*} & - {( {A}_{2} - {C}_{2} )}^{*} & {( {A}_{1} - {C}_{1} )}^{*}\end{matrix} ] \qquad ( 3 )$$

where the row of matrix represents the time and the column of matrix represents the antenna index. Review of Equation 3 indicates that there is the interference existing on the different symbols between the different antennas and same antennas, requiring use of a different receiver algorithm from the reception of an Alamouti coded system.

MIMO Multicode MC-CDMA system have two interferences; one is inter-code interference between the multicode under the multipath fading channel; another is inter-antenna interference caused from the independent stream of different antennas. Those two inferences will affect the system performance seriously and even make the system not working normally.

Under this situation other MIMO schemes combining pure MIMO pure spatial multiplexing scheme and MIMO diversity scheme appears, for example, DABBA (double ABBA scheme for multiple antenna system), which can provide more diversity and smaller interference between the antennas.

But when DABBA is used in MC-CDMA system, as in conventional detection method separate components will be used for DABBA detection and despreading for multicode, which can not completely mitigate those previous two interferences so this kind of algorithm is not optimal from the interference mitigation point of view. Because during first step of DABBA detection we ignore the existence of inter-code interference caused by multicode spreading; for second step of dispreading over multicode we still ignore the inter-antenna interference caused by multiple antenna transmission. Based on this separated algorithm the performance for DABBA MC-CDMA should not be very good.

The unified receiver structure formed of the different multiple antennas no matter it is DABBA or DSTTD, or others; first get the signal reception matrix into standard reception signal matrix form where those two interferences are considered together to be mitigated at the same time. During the derivation of standard signal matrix from the DABBA signal matrix the multiple dimension (multiple antenna) is converted into one dimension. The standard signal matrix form is defined as
Y=HX+N standard signal matrix form

After getting this matrix form MIMO detection, is used, such as BLAST, QRD-M algorithm to output the desired signal from the previous formula.

Due to the mitigation of those two interference (inter-code and inter-antenna) at the same time (not separately), this algorithm is optimal for the receiver of DABBA MC-CDMA from the interference point of view compared to separated components used for DABBA MC-CDMA system.

Due to the mitigation of those two interference (inter-code and inter-antenna) at the same time (not separately), this algorithm is optimal for the receiver of DABBA MC-CDMA from the interference point of view compared to separated components used for DABBA MC-CDMA system.

For the different MIMO scheme the signal reception could first be unified into standard signal matrix in which the interference and diversity are considered at the same. Also the multiple user system for MIMO case can be considered and multiple user signal into standard signal matrix as long as the user information of each user is known. Another example, when OFDM modulation is used in multiple cells some scrambling code is used to distinguish the cell. If some information is known about the scrambling code of multiple cells the same method is used to mitigate the multicell interference. So we can mitigate the interference caused by any reason at the same time.

When DABBA is used for the space-time coding in MC-CDMA system the received signal for the first chip is

$${X}_{1} = [ \begin{matrix}{\sum }_{p = 1}^{P} {A}_{1}^{P} {S}_{p1} + {\sum }_{p = 1}^{P} {C}_{1}^{P} {S}_{p1} & {\sum }_{p = 1}^{P} {A}_{2}^{P} {S}_{p1} + {\sum }_{p = 1}^{P} {C}_{2}^{P} {S}_{p1} & {\sum }_{p = 1}^{P} {B}_{1}^{P} {S}_{p1} + {\sum }_{p = 1}^{P} {D}_{1}^{P} {S}_{p1} & {\sum }_{p = 1}^{P} {B}_{2}^{P} {S}_{p1} + {\sum }_{p = 1}^{P} {D}_{2}^{P} {S}_{p1} \\ - {( {\sum }_{p = 1}^{P} {A}_{2}^{P} {S}_{p1} + {\sum }_{p = 1}^{P} {C}_{2}^{P} {S}_{p1} )}^{*} & {( {\sum }_{p = 1}^{P} {A}_{1}^{P} {S}_{p1} + {\sum }_{p = 1}^{P} {C}_{1}^{P} {S}_{p1} )}^{*} & - {( {\sum }_{p = 1}^{P} {B}_{2}^{P} {S}_{p1} + {\sum }_{p = 1}^{P} {D}_{2}^{P} {S}_{p1} )}^{*} & {( {\sum }_{p = 1}^{P} {B}_{1}^{P} {S}_{p1} + {\sum }_{p = 1}^{P} {D}_{1}^{P} {S}_{p1} )}^{*} \\ {\sum }_{p = 1}^{P} {B}_{1}^{P} {S}_{p1} - {\sum }_{p = 1}^{P} {D}_{1}^{P} {S}_{p1} & {\sum }_{p = 1}^{P} {B}_{2}^{P} {S}_{p1} - {\sum }_{p = 1}^{P} {D}_{2}^{P} {S}_{p1} & {\sum }_{p = 1}^{P} {A}_{1}^{P} {S}_{p1} - {\sum }_{p = 1}^{P} {C}_{1}^{P} {S}_{p1} & {\sum }_{p = 1}^{P} {A}_{2}^{P} {S}_{p1} - {\sum }_{p = 1}^{P} {C}_{2}^{P} {S}_{p1} \\ - {( {\sum }_{p = 1}^{P} {B}_{2}^{P} {S}_{p1} - {\sum }_{p = 1}^{P} {D}_{2}^{P} {S}_{p1} )}^{*} & {( {\sum }_{p = 1}^{P} {B}_{1}^{P} {S}_{p1} - {\sum }_{p = 1}^{P} {D}_{1}^{P} {S}_{p1} )}^{*} & - {( {\sum }_{p = 1}^{P} {A}_{2}^{P} {S}_{p1} - {\sum }_{p = 1}^{P} {C}_{2}^{P} {S}_{p1} )}^{*} & {( {\sum }_{p = 1}^{P} {A}_{1}^{P} {S}_{p1} - {\sum }_{p = 1}^{P} {C}_{1}^{P} {S}_{p1} )}^{*}\end{matrix} ] \qquad ( 4 )$$

where MC-CDMA uses the multicode spreading to get full data rate as OFDM, and Sₚ₁ is the 1^{st} chip of the p-th spreading code and the multicode number is denoted as P; X₁ represents the 1^{st} chip block signal of DABBA coded symbol.

The received signal for DABBA coded MC-CDMA can be written as for the different chips.

$$[ \begin{matrix}{y}_{11 , 1} & {y}_{12 , 1} & & & \\ {y}_{21 , 1} & {y}_{22 , 1} & & & \\ {y}_{31 , 1} & {y}_{32 , 1} & & & \\ {y}_{41 , 1} & {y}_{42 , 1} & & & \\ & & {y}_{11 , 2} & {y}_{12 , 2} & \\ & & {y}_{21 , 2} & {y}_{22 , 2} & \\ & & {y}_{31 , 2} & {y}_{32 , 2} & \\ & & {y}_{41 , 2} & {y}_{42 , 2} & \\ & & & & ⋰\end{matrix} ] = [ \begin{matrix}{X}_{1} & & \\ & {X}_{2} & \\ & & ⋰\end{matrix} ] \cdot [ \begin{matrix}{h}_{11 , 1} & {h}_{12 , 1} & & & \\ {h}_{21 , 1} & {h}_{22 , 1} & & & \\ {h}_{31 , 1} & {h}_{32 , 1} & & & \\ {h}_{41 , 1} & {h}_{42 , 1} & & & \\ & & {h}_{11 , 2} & {h}_{12 , 2} & \\ & & {h}_{21 , 2} & {h}_{22 , 2} & \\ & & {h}_{31 , 2} & {h}_{32 , 2} & \\ & & {h}_{41 , 2} & {h}_{42 , 2} & \\ & & & & ⋰\end{matrix} ] + N$$

Where y_{ij,l} denotes the received signal of l-th chip over the i-th receiver antenna from j-th transmission antenna and Xₗ is the DABBA coded symbol block over the l-th chip; N is the AWGN noise matrix. This equation (5) is simplified by selecting the first chip symbols of the spreading DABBA code to form the following:

$$\begin{matrix}{Y}^{1} = [ \begin{matrix}{y}_{11 , 1} \\ {y}_{21 , 1} \\ {y}_{31 , 1} \\ {y}_{41 , 1} \\ {y}_{12 , 1} \\ {y}_{22 , 1} \\ {y}_{32 , 1} \\ {y}_{42 , 1}\end{matrix} ] \\ = [ \begin{matrix}{h}_{11 , 1} & {h}_{21 , 1} & {h}_{31 , 1} & {h}_{41 , 1} & {h}_{11 , 1} & {h}_{21 , 1} & {h}_{31 , 1} & {h}_{41 , 1} \\ {h}_{21 , 1}^{*} & - {h}_{11 , 1}^{*} & {h}_{41 , 1}^{*} & - {h}_{31 , 1}^{*} & {h}_{21 , 1}^{*} & - {h}_{11 , 1}^{*} & {h}_{41 , 1}^{*} & - {h}_{31 , 1}^{*} \\ {h}_{31 , 1} & {h}_{41 , 1} & {h}_{11 , 1} & {h}_{21 , 1} & - {h}_{31 , 1} & - {h}_{41 , 1} & - {h}_{11 , 1} & - {h}_{21 , 1} \\ {h}_{41 , 1}^{*} & - {h}_{31 , 1}^{*} & {h}_{21 , 1}^{*} & - {h}_{11 , 1}^{*} & - {h}_{41 , 1}^{*} & {h}_{31 , 1}^{*} & - {h}_{21 , 1}^{*} & {h}_{11 , 1}^{*} \\ {h}_{12 , 1} & {h}_{22 , 1} & {h}_{32 , 1} & {h}_{42 , 1} & {h}_{12 , 1} & {h}_{22 , 1} & {h}_{32 , 1} & {h}_{42 , 1} \\ {h}_{22 , 1}^{*} & - {h}_{12 , 1}^{*} & {h}_{42 , 1}^{*} & - {h}_{32 , 1}^{*} & {h}_{22 , 1}^{*} & - {h}_{12 , 1}^{*} & {h}_{42 , 1}^{*} & - {h}_{32 , 1}^{*} \\ {h}_{32 , 1} & {h}_{42 , 1} & {h}_{12 , 1} & {h}_{22 , 1} & - {h}_{32 , 1} & - {h}_{42 , 1} & - {h}_{12 , 1} & - {h}_{22 , 1} \\ {h}_{42 , 1}^{*} & - {h}_{32 , 1}^{*} & {h}_{22 , 1}^{*} & - {h}_{12 , 1}^{*} & - {h}_{42 , 1}^{*} & {h}_{32 , 1}^{*} & - {h}_{22 , 1}^{*} & {h}_{12 , 1}^{*}\end{matrix} ] \cdot [ \begin{matrix}{\sum }_{p = 1}^{P} {A}_{1}^{P} {S}_{p1} \\ {\sum }_{p = 1}^{P} {A}_{2}^{P} {S}_{p1} \\ {\sum }_{p = 1}^{P} {B}_{1}^{P} {S}_{p1} \\ {\sum }_{p = 1}^{P} {B}_{2}^{P} {S}_{p1} \\ {\sum }_{p = 1}^{P} {C}_{1}^{P} {S}_{p1} \\ {\sum }_{p = 1}^{P} {C}_{2}^{P} {S}_{p1} \\ {\sum }_{p = 1}^{P} {D}_{1}^{P} {S}_{p1} \\ {\sum }_{p = 1}^{P} {D}_{2}^{P} {S}_{p1}\end{matrix} ]\end{matrix}$$

The received signal over other chips can also be written into the similar block matrix. The input symbols {A₁, A₂, B₁, B₂, C₁, C₂, D₁, D₂} are replaced by one single same symbol D={D₁, D₂, D₃, D₄, D₅, D₆, D₇, D₈} for the simplicity of the derivation.

The matrix formula (6) is rewritten into vector or scalar equation,

$$\begin{matrix}{\overline{y}}_{m}^{i} = {\sum }_{n = 1}^{8} {H}_{mn}^{i} {\sum }_{p = 1}^{P} {D}_{n}^{p} {S}_{pi} + {η}_{m , i} \\ = {\sum }_{p = 1}^{P} {S}_{pi} \cdot {\sum }_{n = 1}^{8} ( {H}_{mn}^{i} \cdot {D}_{n}^{p} ) + {η}_{m , i}\end{matrix} \qquad ( 7 )$$

Where \overline{y}ₘⁱ denotes the m-th row value of the i-th chip DABBA code symbol Yⁱ and Hₘₙⁱ is the m-th row n-th column value of the i-th chip channel matrix H, p is the multicode index of spreading code sets and i is the chip index of one spreading code; η_{m,i} is the AWGN noise.

Based on the formula, the standard received signal matrix form for the first chip DABBA code symbol block is obtained.

$$\begin{matrix}[ \begin{matrix}{y}_{11 , 1} \\ {y}_{21 , 1} \\ {y}_{31 , 1} \\ {y}_{41 , 1} \\ {y}_{12 , 1} \\ {y}_{22 , 1} \\ {y}_{32 , 1} \\ {y}_{42 , 1}\end{matrix} ] = [ \begin{matrix}{\overline{y}}_{1}^{1} \\ {\overline{y}}_{2}^{1} \\ {\overline{y}}_{3}^{1} \\ {\overline{y}}_{4}^{1} \\ {\overline{y}}_{5}^{1} \\ {\overline{y}}_{6}^{1} \\ {\overline{y}}_{7}^{1} \\ {\overline{y}}_{8}^{1}\end{matrix} ] \\ = {[ \begin{matrix}{s}_{11} & {s}_{21} & ⋯ & {s}_{P1} & & & & & & & & & \\ & & & & {s}_{11} & {s}_{21} & ⋯ & {s}_{P1} & & & & & \\ & & & & & & & & ⋯ & & & & \\ & & & & & & & & & {s}_{11} & {s}_{21} & ⋯ & {s}_{P1}\end{matrix} ]}_{8 \times 8 P} \times \\ {[ \begin{matrix}\begin{matrix}{h}_{11} & {h}_{12} & ⋯ & {h}_{18} \\ & & & \\ & & & \\ & & & \end{matrix} & \begin{matrix} & & & \\ {h}_{11} & {h}_{12} & ⋯ & {h}_{18} \\ & & & \\ & & & \end{matrix} & \begin{matrix} \\ \\ ⋯ \\ \end{matrix} & \begin{matrix} & & & \\ & & & \\ & & & \\ {h}_{11} & {h}_{12} & ⋯ & {h}_{18}\end{matrix} \\ ⋮ & ⋮ & ⋮ & ⋮ \\ \begin{matrix}{h}_{81} & {h}_{82} & ⋯ & {h}_{88} \\ & & & \\ & & & \\ & & & \end{matrix} & \begin{matrix} & & & \\ {h}_{81} & {h}_{82} & ⋯ & {h}_{88} \\ & & & \\ & & & \end{matrix} & \begin{matrix} \\ \\ ⋯ \\ \end{matrix} & \begin{matrix} & & & \\ & & & \\ & & & \\ {h}_{81} & {h}_{82} & ⋯ & {h}_{88}\end{matrix}\end{matrix} ]}_{648 \times 64} \times {[ \begin{matrix}{D}_{1}^{1} \\ ⋮ \\ {D}_{8}^{1} \\ ⋮ \\ ⋮ \\ {D}_{1}^{8} \\ ⋮ \\ {D}_{8}^{8}\end{matrix} ]}_{64 \times 1} + \overline{η}\end{matrix} \qquad ( 8 )$$

In vector form, the equation is alternately represented as:
Y¹=S¹·H¹·D+\overline{η} (9)
Then, the received signal over all chips is obtained over one spreading factor length.

$$\begin{matrix}Y = [ \begin{matrix}{Y}^{1} \\ {Y}^{2} \\ {Y}^{P}\end{matrix} ] \\ = [ \begin{matrix}{S}^{1} & & & \\ & {S}^{2} & & \\ & & ⋰ & \\ & & & {S}^{P}\end{matrix} ] \cdot [ \begin{matrix}{H}^{1} \\ {H}^{2} \\ ⋮ \\ {H}^{P}\end{matrix} ] \cdot D + \hat{η} \\ = \overline{S} \cdot \overline{H} \cdot D + \hat{η}\end{matrix} \qquad ( 10 )$$

Applying the MRC principle to maximum SNR (\overline{S}·\overline{H})^{H} is multiplied to both of the parts of the equation (10) to obtain:
\tilde{Y}=RD+\hat{\hat{η}} (11)
where \tilde{Y}=(\overline{S}·\overline{H})^{H}·Y, R=(\overline{S}·\overline{H})^{H}·(\overline{S}·\overline{H}) and \hat{\hat{η}}=(\overline{S}·\overline{H})^{H}·\hat{η}.

The equation (11) has the same form as standard received signal matrix (1). In the following the general MIMO algorithm is employed, for example, BLAST, QRD-M algorithm to detect the data symbol D in the equation (11).

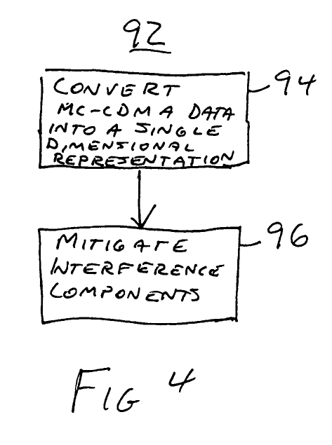

FIG. 4 illustrates a method flow diagram, shown generally at 92, representative of the method of operation of an embodiment of the present invention. The method facilitates data reception at an MIMO receiver that receives coded, multi-carrier, CDMA-modulated data at a set of receive antennas transmitted upon channels susceptible to distortion.

First, and as indicated by the block 94, indications of the coded, multi-carrier, CDMA-modulated data received at the receiver is converted into a single-dimensional data representation. The received data is, e.g., DABBA-coded data.

Then, and as indicated by the block 96, interference components of the single-dimensional data representation of the data into which the indications of the received data is converted are together mitigated. The interference components include both inter-antenna interference and inter-code interference.

Thereby, through operation of an embodiment of the present invention, manner is provided by which to mitigate the effects of inter-code and inter-antenna interference introduced upon data communicated in an MIMO communication system that utilized coded, MC-CDMA communication schemes. Because the interference is mitigated, and proved receiver operation is provided.

The previous descriptions are of preferred examples for implementing the invention, and the scope of the invention should not necessarily be limited by this description. The scope of the present invention is defined by the following claims.

What is claimed is:

1. Apparatus for facilitating data reception at a MIMO receiver that receives coded, multi-carrier CDMA-modulated data at a set of receive antennas upon channels susceptible to distortion, said apparatus comprising:
a dimension converter adapted to receive indications of the coded, multi-carrier CDMA-modulated data detected at each receive antenna of the set of receive antennas, said dimension converter for converting the indications of the coded, multi-carrier CDMA-modulated data into a single-dimensional data representation; and
an interference mitigator adapted to receive indications of the single-dimensional data representation formed by said dimension converter, said interference mitigator for mitigating interference introduced upon the coded, multi-carrier CDMA-modulated data during communication thereof upon the channels.

2. The apparatus of claim 1 wherein the coded, multi-carrier CDMA-modulated data of which said dimension converter is adapted to receive comprises non-orthogonally-coded, multi-carrier CDMA-modulated data.

3. The apparatus of claim 2 wherein the non-orthogonally-coded, multi-carrier CDMA-modulated data of which said dimension converter is adapted to receive comprises a DABBA-coded multi-carrier CDMA-modulated data.

4. The apparatus of claim 1 wherein the set of receive antennas comprises a first receive antenna and a second receive antenna, wherein the indications of the coded, multi-carrier, CDMA-modulated data is two-dimensional, and wherein said dimension converter comprises a two-dimension to one-dimension converter for converting the indications into the single-dimensional data representation.

5. The apparatus of claim 1 wherein said interference mitigator comprises a data decoder that decodes the indications of the single-dimensional data to form a decoded representation thereof, the decoded representation free of the interference.

6. The apparatus of claim 5 wherein the coded, multi-carrier CDMA-modulated data is block-encoded and wherein said data decoded comprises a block decoder.

7. The apparatus of claim 1 wherein the interference mitigated by said interference mitigator comprises inter-antenna interference.

8. The apparatus of claim 1 wherein the interference mitigated by said interference mitigator comprises inter-code interference.

9. The apparatus of claim 1 wherein said dimension converter comprises a multiplier adapted to receive the indications of the coded, multi-carrier CDMA-modulated data detailed at each of the receive antennas, said multiplier for multiplying the indications by a matrix multiplicand.

10. The apparatus of claim 9 wherein the matrix multiplicand by which said multiplier multiplies the indications of the coded, multi-carrier CDMA-modulated data comprises values representative of the channels upon which the data is communicated.

11. The apparatus of claim 10 wherein the matrix multiplicand by which said multiplier multiplies the indications of the coded, multi-carrier CDMA-modulated data comprises values representative of spreading codes by which the data is coded.

12. The apparatus of claim 11 wherein the matrix multiplicand comprises a Hermetian of a matrix formed of a combination of a channel matrix and a spreading code matrix.

13. The apparatus of claim 1 further comprising Fourier transformers associated with each receive antenna of the set of receive antennas, and wherein the indications of the coded, multi-carrier CDMA-modulated data received by said dimension converter comprise Fourier-transformed representations thereof.

14. A method for facilitating data reception at a MIMO receiver that receives coded, multi-carrier, CDMA-modulated data at a set of receive antennas upon channels susceptible to distortion, said method comprising the operations of:
converting indications of the coded, multi-carrier, CDMA-modulated data received at the receiver into a single-dimensional data representation; and
mitigating interference components of the single-dimensional data representation of the data introducaed upon the data during communication thereof upon the channels.

15. The method of claim 14 wherein the indications of the coded, multi-carrier, CDMA-modulated data converted during said operation of converting comprise indications of DABBA-coded, multi-carrier CDMA-modulated data.

16. The method of claim 14 wherein said operation of mitigating comprises decoding the indications of the single-dimensional data to form a decoded representation thereof, the decoded representation free of interference.

17. The method of claim 14 wherein the interference mitigated during said operation of mitigating comprises inter-antenna interference.

18. The method of claim 14 wherein the interference mitigated during said operation of mitigating comprises inter-code interference.

19. The method of claim 14 wherein said operation of converting comprises multiplying the indications by a matrix multiplicand.

20. The method of claim 19 wherein said operation of multiplying comprises multiplying the indications by a Hermetian of a matrix formed of a combination of a channel matrix and a spreading code matrix.
